(19) United States
(12) Patent Application Publication
(10) Pub. No.: US 2024/0224050 A1
(43) Pub. Date: Jul. 4, 2024

(54) Public Network Integration Non-Public Network Evolution

(71) Applicant: Celona, Inc., Campbell, CA (US)

(72) Inventors: Srinivasan Balasubramanian, San Diego, CA (US); John Taylor, Campbell, CA (US)

(21) Appl. No.: 18/397,043

(22) Filed: Dec. 27, 2023

Related U.S. Application Data
(60) Provisional application No. 63/478,295, filed on Jan. 3, 2023.

(51) Int. Cl. H04W 12/64; H04W 12/08; H04W 64/00; H04W 88/06

(52) U.S. Cl. CPC H04W 12/64; H04W 12/08; H04W 64/006; H04W 88/06

(57) ABSTRACT

Various embodiments of a method and apparatus for support of private network deployed with integrated with public networks. The end user devices connect with the 4^{th} generation Long Term Evolution (4G LTE) and 5^{th} generation New Radio (5G NR) enterprise networks with different credentials each with a specific Public Land Mobile Network Identifier (PLMN-ID). Based on the associated PLMN-ID of the end user device, the evolved Node-B (eNB)/gNB routes the core network connectivity to the enterprise private core or to the macro network core. The macro network core determines if the end user device needs to be associated with the macro network anchored user plane function (UPF) or with the dedicated Data Network Name (DNN) that is anchored in the enterprise core network. Mechanism to determine the enterprise to associate the dedicated DNN is done based on the end user device proximity to the specific enterprise and routing to find the UPF anchor in the enterprise determined by the Network Routing Function (NRF). Additionally, the end-user device is authorized to enter the enterprise campus network to ensure access is provided only for specific devices that have the appropriate access privileges into the enterprise.

### CLAIM OF PRIORITY TO PREVIOUSLY FILED PROVISIONAL APPLICATION—INCORPORATION BY REFERENCE

This non-provisional application claims priority to an earlier-filed provisional application No. 63/478,295 filed Jan. 3, 2023, entitled “Public Network Integration Non-Public Network Evolution” (ATTY DOCKET NO. CEL-101-PROV), and all its contents, are hereby incorporated by reference herein as if set forth in full.’

### (1) TECHNICAL FIELD

The disclosed method and apparatus relate generally to systems for managing non-public networks. In particular, the disclosed method and apparatus relate to support of public networks integrated for operations to service non-public networks otherwise termed as private networks.

### (2) BACKGROUND

FIG. 1 presents the 4^{th} generation (4G) Long Term Evolution (LTE) Evolved Packet Core (EPC) and 5^{th} generation (5G) New Radio (NR) 5^{th} generation core (5GC) network architecture and interfaces.

FIG. 2 presents the 4G LTE EPC private network architecture. This describes the scenario where the eNB and the packet network networks are deployed in the enterprise campus with IP connectivity into the enterprise network via specific VLAN associations.

FIG. 3 presents the 4G LTE EPC private network architecture along with the Multi-Operator Core Network Gateway (MOCN GW) connectivity to Mobile Network Operator (MNO) core network.

FIG. 4 presents the 5G NR 5GC private network architecture. This describes the scenario where the gNB and the packet network networks are deployed in the enterprise campus with IP connectivity into the enterprise network via specific VLAN associations.

FIG. 5 presents the 5G NR 5GC private network architecture along with the Multi-Operator Core Network Gateway (MOCN GW) connectivity to Mobile Network Operator (MNO) core network. The connectivity to the private network and the MNO network is segregated by the PLMN associated with the end-user device associating with the network.

### SUMMARY

Various embodiments of a method and apparatus for support of private network deployed with integrated with public networks. The end user devices connect with the 4^{th} generation Long Term Evolution (4G LTE) and 5^{th} generation New Radio (5G NR) enterprise networks with different credentials each with a specific Public Land Mobile Network Identifier (PLMN-ID). Based on the associated PLMN-ID of the end user device, the evolved Node-B (eNB)/gNB routes the core network connectivity to the enterprise private core or to the macro network core. The macro network core determines if the end user device needs to be associated with the macro network anchored user plane function (UPF) or with the dedicated Data Network Name (DNN) that is anchored in the enterprise network. Mechanism to determine the enterprise to associate the dedicated DNN is done based on the end user device proximity to the specific enterprise and routing to find the UPF anchor in the enterprise determine by the Network Routing Function (NRF). Additionally, the end-user device is authorized to enter the enterprise campus network to ensure access is provided only for specific devices that have the appropriate access privileges into the enterprise.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 presents the 4^{th} generation (4G) Long Term Evolution (LTE) Evolved Packet Core (EPC) and 5^{th} generation (5G) New Radio (NR) 5^{th} generation core (5GC) network architecture and interfaces.

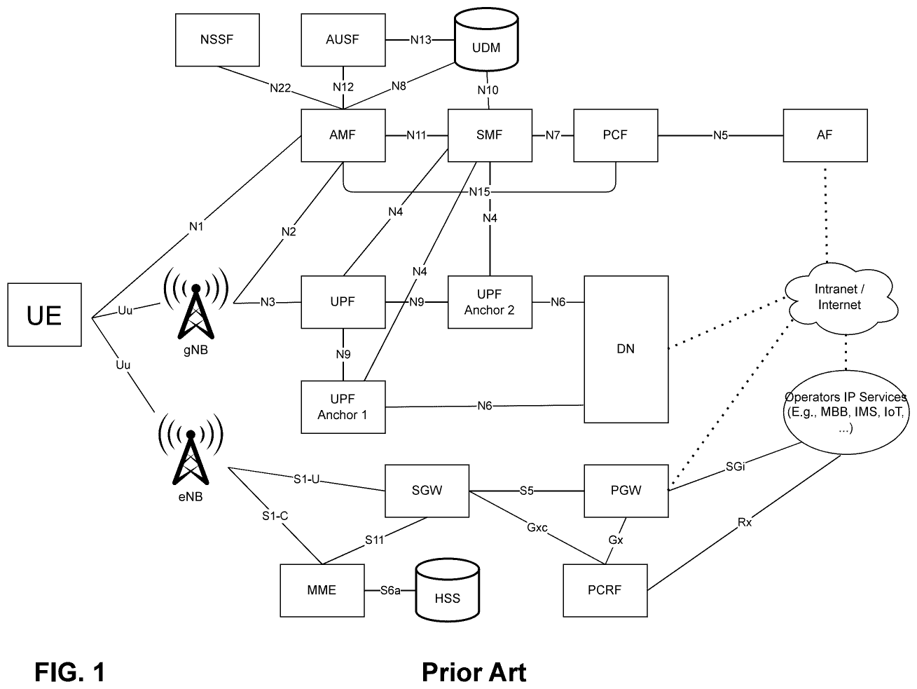

FIG. 2 presents the 4G LTE EPC private network architecture.

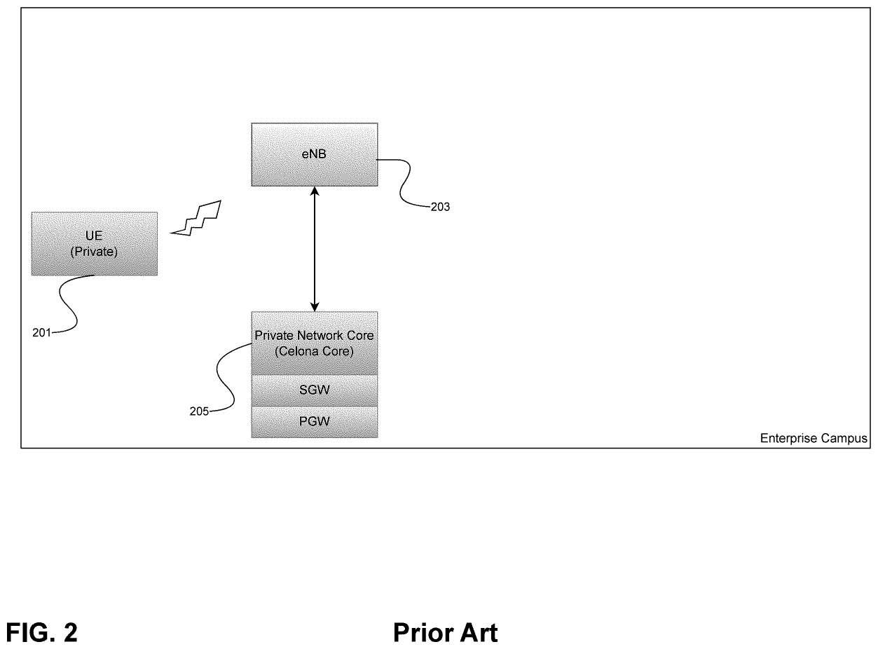

FIG. 3 presents the 4G LTE EPC private network architecture along with the Multi-Operator Core Network Gateway (MOCN GW) connectivity to Mobile Network Operator (MNO) core network.

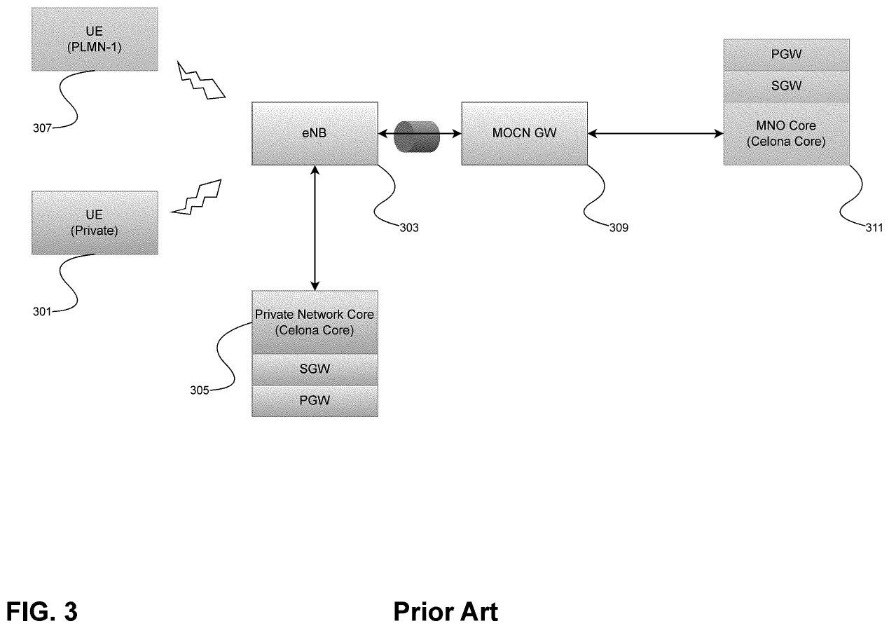

FIG. 4 presents the 5G NR 5GC private network architecture.

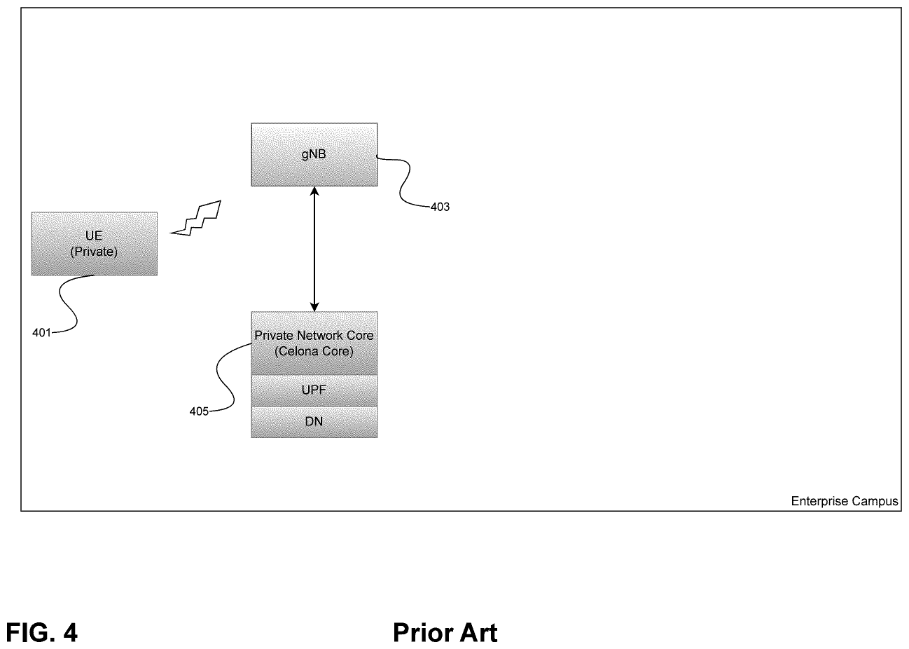

FIG. 5 presents the 5G NR 5GC private network architecture along with the Multi-Operator Core Network Gateway (MOCN GW) connectivity to Mobile Network Operator (MNO) core network. The connectivity to the private network and the MNO network is segregated by the PLMN associated with the end-user device associating with the network.

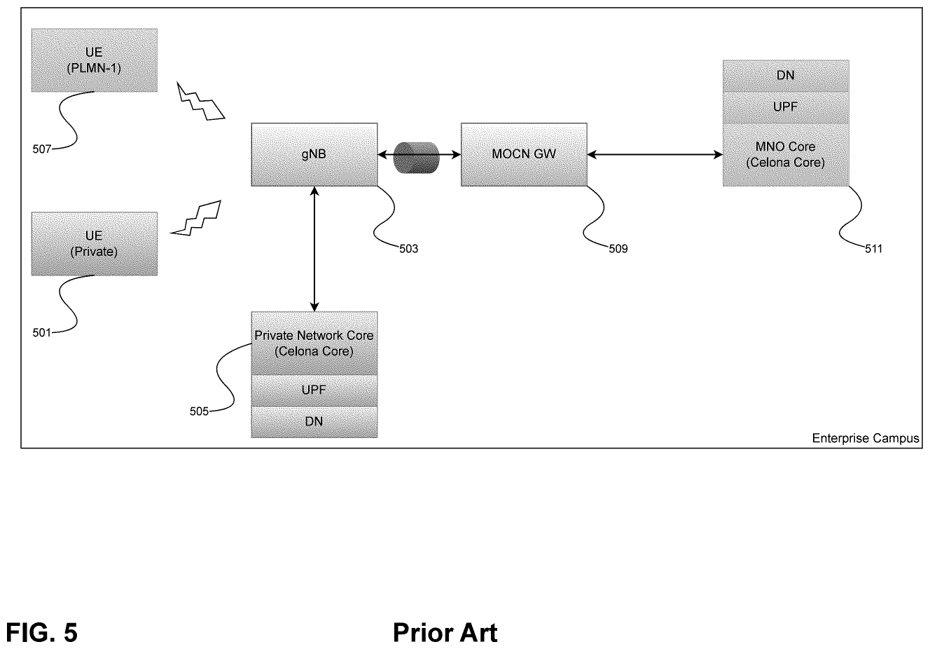

FIG. 6 presents extension to private network, MOCN GW, and MNO core network to extend the provided dedicated data network name (DNN) with control plane supported from MNO core network while proving the user plane connectivity from the enterprise network.

FIG. 7 presents extension to private network, MOCN GW, and MNO core network to extend the provided dedicated data network name (DNN) with control plane supported from MNO core network while proving the user plane connectivity from the enterprise network with the enterprise functions secured behavior a firewall and the connectivity between the MNO core and enterprise network protected with a secure tunnel.

FIG. 8 presents extension to private network, MOCN GW, and MNO core network to extend the provided dedicated data network name (DNN) with control plane supported from independent core network segregated from end-user devices connecting to the MNO core while proving the user plane connectivity from the enterprise network.

FIG. 9 presents extension to private network, MOCN GW, and MNO core network to extend the provided dedicated data network name (DNN) with control plane supported from independent core network segregated from end-user devices connecting to the MNO core while proving the user plane connectivity from the enterprise network with the enterprise functions secured behavior a firewall and the connectivity between the MNO core and enterprise network protected with a secure tunnel.

FIG. 10 presents the phased evolution of the network deployments.

FIG. 11 presents the method of establishing the N4 interface from the MNO core discovering the end-user proximity to a given enterprise and the hence discover the User Plane Function (UFP) in the associated enterprise network. This discovery function is built into an MNO core based on a geolocation determination made using a geo-position system, such as Location Based Services (LBS) which is aided by Geo Positioning System (GPS) and/or macro network cell measurements.

FIG. 12 presents the method of establishing the N4 interface from the MNO core discovering the end-user proximity to a given enterprise and the hence discover the User Plane Function (UFP) in the associated enterprise network. This discovery function is built independent of MNO core based on the geolocation determination using Location Based Services (LBS) which is aided by Geo Positioning System (GPS) and/or macro network cell measurements and reported to an Extranet Network Routing Function (NRF). The Extranet NRF identifies Intranet NRF within the enterprise network and the Intranet NRF ensures that only authorized users enter the specific enterprise campus.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

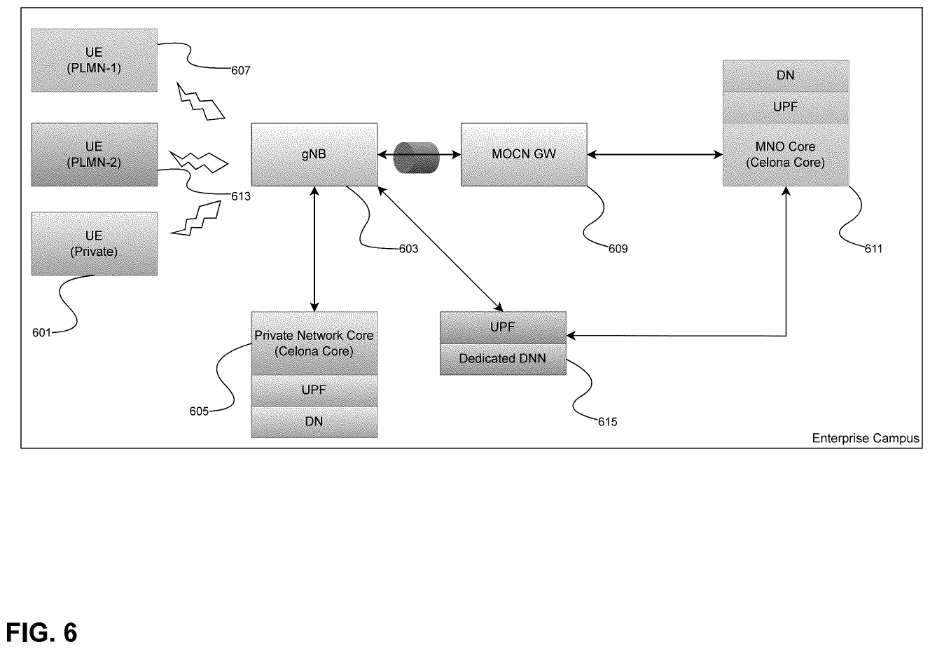

FIG. 6 presents extension to private network, MOCN GW, and MNO core network to extend the provided dedicated data network name (DNN) with control plane supported from MNO core network while proving the user plane connectivity from the enterprise network.

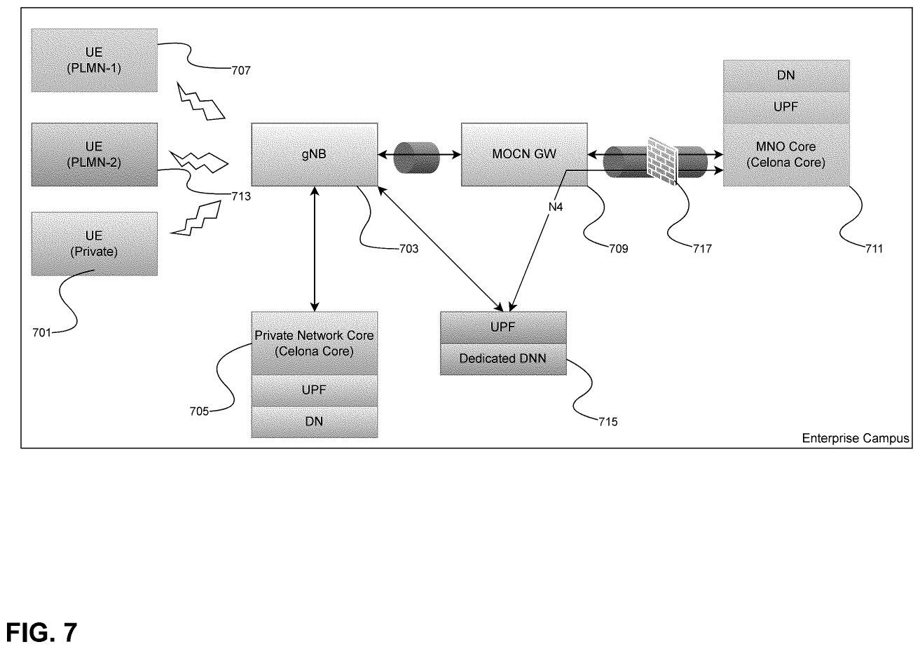

FIG. 7 presents extension to private network, MOCN GW, and MNO core network to extend the provided dedicated data network name (DNN) with control plane supported from MNO core network while proving the user plane connectivity from the enterprise network with the enterprise functions secured behavior a firewall and the connectivity between the MNO core and enterprise network protected with a secure tunnel.

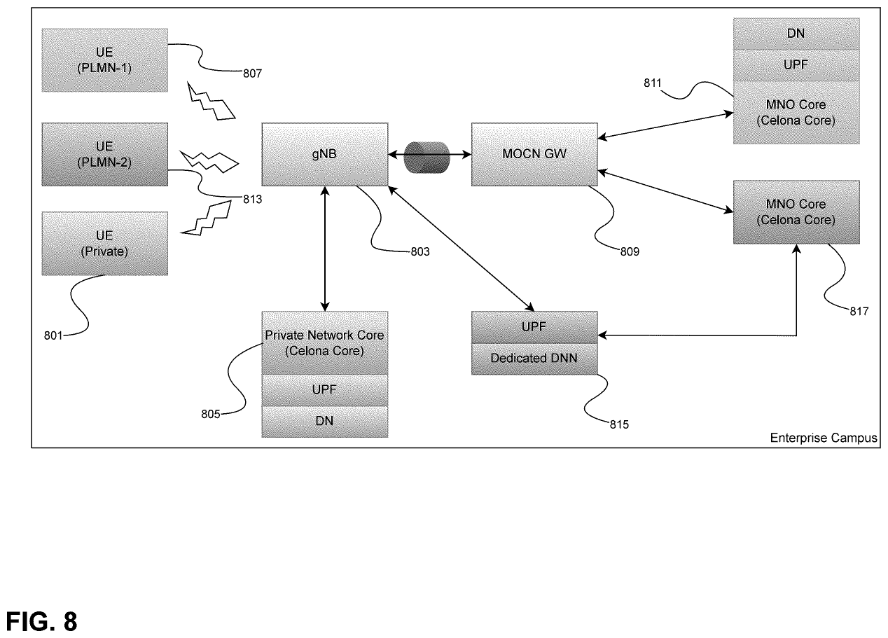

FIG. 8 presents extension to private network, MOCN GW, and MNO core network to extend the provided dedicated data network name (DNN) with control plane supported from independent core network segregated from end-user devices connecting to the MNO core while proving the user plane connectivity from the enterprise network.

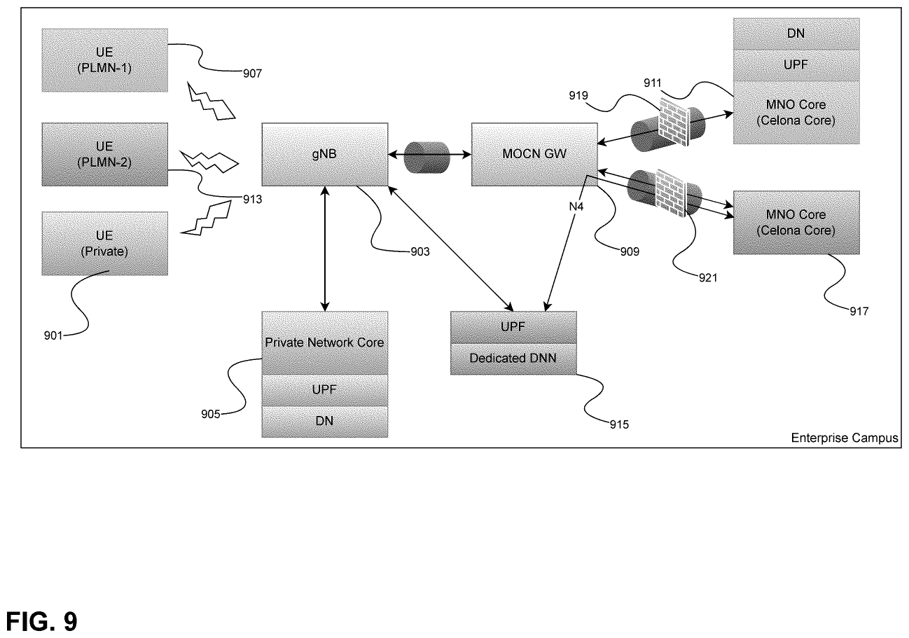

FIG. 9 presents extension to private network, MOCN GW, and MNO core network to extend the provided dedicated data network name (DNN) with control plane supported from independent core network segregated from end-user devices connecting to the MNO core while proving the user plane connectivity from the enterprise network with the enterprise functions secured behavior a firewall and the connectivity between the MNO core and enterprise network protected with a secure tunnel.

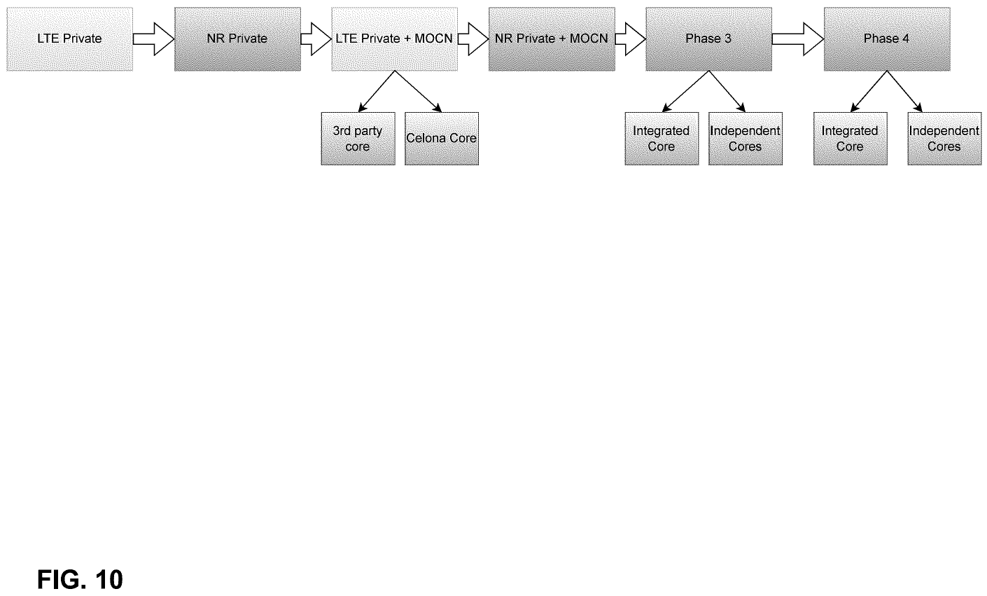

FIG. 10 presents the phased evolution of the network deployments. This is a suggested evolution and the different phases can be used without specific dependency to the previous phases.

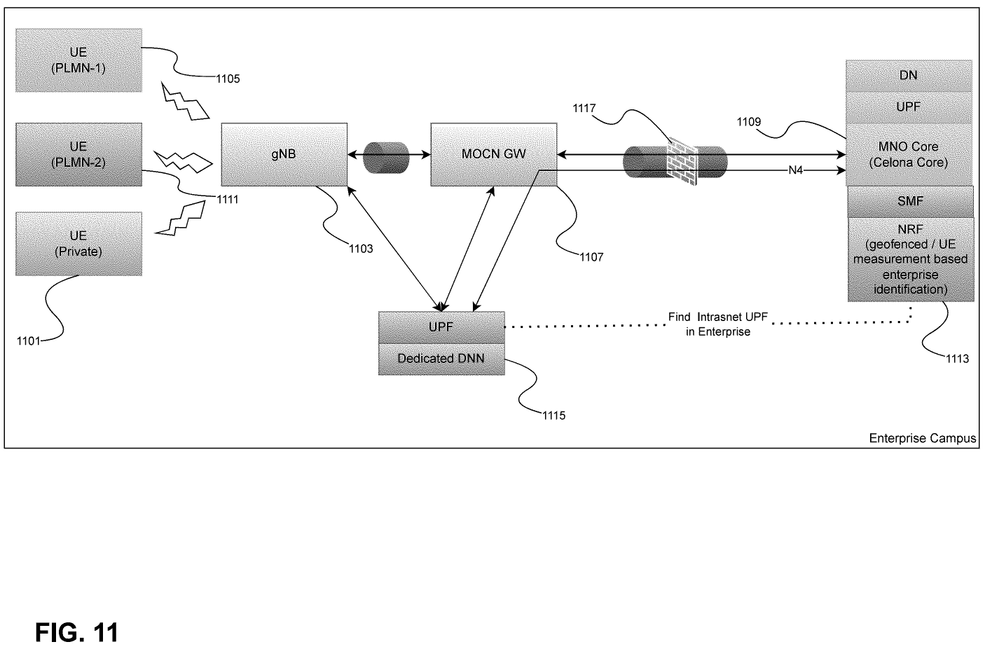

FIG. 11 presents the method of establishing the N4 interface from the MNO core discovering the end-user proximity to a given enterprise and the hence discover the User Plane Function (UFP) in the associated enterprise network. This discovery function is built into MNO core based on the geolocation determination using Location Based Services (LBS) which is aided by Geo Positioning System (GPS) and/or macro network cell measurements.

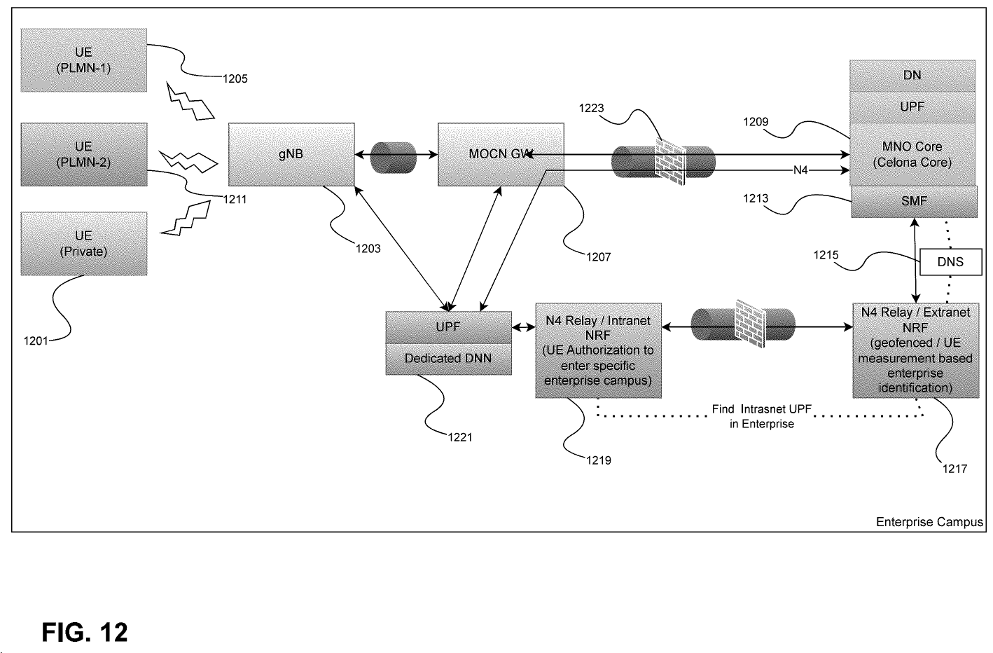

FIG. 12 presents the method of establishing the N4 interface from the MNO core discovering the end-user proximity to a given enterprise and the hence discover the User Plane Function (UFP) in the associated enterprise network. This discovery function is built independent of MNO core based on the geolocation determination using Location Based Services (LBS) which is aided by Geo Positioning System (GPS) and/or macro network cell measurements and reported to an Extranet Network Routing Function (NRF). The Extranet NRF identifies Intranet NRF within the enterprise network and the Intranet NRF ensures that only authorized users enter the specific enterprise campus.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
a) a processor;
b) a memory system having a non-transitory computer-readable medium storing one or more computer instructions, which when implemented cause the processor to:
i) designate a collection of enterprise networks; and
ii) support access points providing connectivity to multiple device credential types;
iii) support routing to a private core or a macro network core; and
iv) attain macro network core anchoring of IP context of an end user device to at least one of: (1) a macro network; and (2) at least one of the collection of enterprise networks;
wherein the at least one of the collection of enterprise networks to which the IP context is anchored supports private and public network connectivity.

2. The system of claim 1, wherein:
the at least one of the collection of enterprise networks is determined based on the current end user location; and
comparing the current end use location with a known enterprise geofence;

3. The system of claim 2, wherein:
the end user device has a location that is determined based on at least one of: (1) a geo-positioning system; and (2) measurements of at least one macro network cell.
